(19) United States
(12) Patent Application Publication
(10) Pub. No.: US 2013/0120996 A1
(43) Pub. Date: May 16, 2013

(54) Thermal Transformer for LED Lighting Applications

(71) Applicant: ROBERTSON TRANSFORMER CO., Blue Island, IL (US)

(72) Inventors: Denny D. Beasley, La Grange Park, IL (US); Peter W. Shackle, Rolling Hills Estates, CA (US)

(73) Assignee: ROBERTSON TRANSFORMER CO., Blue Island, IL (US)

(21) Appl. No.: 13/721,868

(22) Filed: Dec. 20, 2012

Related U.S. Application Data
(63) Continuation-in-part of application No. 13/364,713, filed on Feb. 2, 2012.
Application No. 13/364,713 is a continuation-in-part of application No. 13/375,060, filed on Oct. 22, 2012.
(60) Provisional application No. 61/298,406, filed on Jan. 26, 2010.

(51) Int. Cl. F21V 29/00

(52) U.S. Cl. CPC F21V 29/22
USPC 362/249.02; 165/185; 427/402; 427/407.1

(57) ABSTRACT

A method of passively dissipating heat from a source of heat is described. A plurality of successive layers of thermally conductive materials is formed where each layer has a thermal conductivity less than a thermal conductivity of a preceding layer. The plurality of successive layers has a first layer, a second layer, and a third layer in stacked relationship. Thermal impedances of the plurality of successive layers from one layer to an adjacent layer in the plurality of successive layers are matched by controlling a volume of one layer relative to an adjacent layer in the plurality of successive layers.

### CROSS-REFERENCE TO RELATED APPLICATIONS

This Application is a continuation-in-part application of co-pending U.S. application Ser. No. 13/364,713 filed on Feb. 2, 2012 which is a continuation-in-part of co-pending U.S. application Ser. No. 13/375,060 filed on Nov. 29, 2011 which is a national stage filing under 35 U.S.C. §371 of PCT/US2011/022534 which has an international filing date of Jan. 26, 2011 and which was published as WO 2011/094282 A1 on Aug. 4, 2011 and which claimed the benefit of U.S. Provisional Patent Application No. 61/298,406 filed Jan. 26, 2010. The contents of all four applications are incorporated herein by reference as if fully set forth herein.

### FEDERALLY SPONSORED RESEARCH OR DEVELOPMENT

N/A

### TECHNICAL FIELD

The invention relates to heat management systems. More particularly, the invention relates to heat management systems for light emitting diodes (LEDs) wherein heat flow from a small LED source with high thermal flux density is transformed into a low density thermal flux over a large area which can then be easily dissipated into the air or into convenient building structures without excessive temperatures being incurred.

### BACKGROUND OF THE INVENTION

The known prior art in thermal management is depicted in FIG. 1. Prior thermal management for a heat source 1 producing a flow of heat 2 typically consists of a larger aluminum heat sink 3 which conducts heat to the air. The term heat sink is used here to specifically describe the apparatus which conducts heat into the air or into some other medium such as a building structure component like a wall or a ceiling. In FIG. 1, the metal is formed to move the flow of heat 2 from the heat source 1 to a plurality of fins 4. The fins 4 act to expand the surface area of the heat sink 3 so that a very poor conductor, air in this case, can convect through the fins 4 and provide a mass flow 5 to carry away the heat. When natural convection is not adequate, a power device typically a blower 6, is used to provide a higher level of mass flow and to gain the desired thermal equilibrium, thus consuming additional energy, increasing the size of the system and adding weight and material cost. Other manifestations of a heat sink can include heat pipes, Peltier coolers and other devices well known to those skilled in the art.

A disparity of thermal impedances makes this process highly ineffective but nearly universally accepted as an adequate and reasonable approach in the art. The thermal conductivity of aluminum is 171 W/mK° (Watts per meter-degree Kelvin) as compared to that of air at 0.018 W/mK. This is nearly three orders of magnitude difference, and is the primary causal agent heat for heat-sink's bulky physicality.

The transfer of heat to air by the process of convection is characterized by a thermal transport coefficient which defines how many watts of heat are dissipated per square meter of surface area per degree K of temperature rise above the ambient. For an aluminum surface in air a number of 10 W/square meter per degree K is reasonable. This coefficient then defines how many square meters of the heat sink are required to dissipate a given number of watts with a given temperature rise.

The need to move the heat with minimal temperature drop necessitates the use of high conductivity metals such as silver, copper or aluminum. Large masses of these metals are needed to provide a low thermal impedance path to the heat sink. This is undesirable since these metals are expensive, difficult to work with, bulky and heavy.

Radiation typically does not come into play in most applications involving living spaces, as radiative cooling only becomes significant at temperatures on the order of hundreds of degree C.

A widespread use of LEDs in industrial lighting is limited by the LEDs sensitivity to temperature. The conventional wisdom is to use classic heat sinking technologies, e.g. finned aluminum, heat pipes, air movement and acoustic oscillation. These methods are expensive and severely limit the design of aesthetically pleasing and practical lighting fixtures.

In U.S. Published Patent Application No. 2006/00888797, Scott describes a dental curing light in which heat is transmitted lengthways down a long thin channel, and then this heat is used to warm up surrounding material with high thermal capacity but low thermal conductivity all along the length of the handle. It is a means for arranging that heat is moved away from the small area being exposed and is temporarily stored by warming up a material with high specific heat which surrounds the conducting channel. In some embodiments, heat is absorbed by melting a solid material into liquid form without any significant temperature change. An airgap is between the heat conducting and heat storage structures and the plastic exterior casing, so that for periods of limited duration little heat is transmitted to the exterior of the device. This contrasts with the subject invention which performs the function of transforming heat from a high density flux over a small area into a low density flux over a large area, on a steady state basis. On a steady state basis, Scott's device does not provide any transformation from high thermal flux density to low thermal flux density. Instead, it channels heat down a conductive path and uses that heat to warm up heat absorbing material surrounding that path. The whole arrangement is designed to function only for a limited time duration, since there is no heat sink (in the sense defined above) to finally dissipate the heat.

In PCT Publication No. WO 2007/013664, Shinozaki describes placing a “heat sink” (his words) made of two different materials under a circuit board, which may or may not have holes in it for LEDs on the top surface to contact the “heat sink” underneath. In one embodiment, the LEDs are connected to a small area of highly conductive metal (like copper) immediately under the LED and the copper is bonded to a low conductivity layer (like aluminum) underneath. First, the heat is transmitted downwards through a relatively massive layer of aluminum. Then, it is transmitted sideways by a copper layer at the bottom. As will be described in detail below, superior results are obtained if first the heat is distributed sideways and only then is it transmitted down through a low conductivity layer. This process of repeatedly spreading heat sideways and then transmitting it downwards through a larger area of lower conductivity material constitutes the subject of this invention which is described here as a “Thermal Transformer.” Low conductivity materials can transmit heat very effectively when it is done over a relatively large area with few watts per unit area.

In U.S. Pat. No. 8,101,966, Yen describes an LED package of small dimensions in which at one stage heat is transmitted sideways before being conducted downwards. However, he fails to teach the advantage that comes from having increasing thermal resistivity at each layer to facilitate the sideways spreading of heat, or the advantage associated with repeated layers to get a large thermal transformation ratio.

It is apparent from the foregoing discussion that in general lighting using LEDs there is a need for a thermal transformer—a structure which can conduct heat from a small heat source such as a light emitting diode to a large area heat sink without using large masses of expensive, heavy and difficult to work metals. A full discussion of the features and advantages of the present invention is deferred to the following detailed description, which proceeds with reference to the accompanying drawings.

### SUMMARY OF THE INVENTION

One aspect of the present invention is directed to a method of passively dissipating heat from a source of heat. The method comprises the steps of: (1) forming a plurality of successive layers of thermally conductive materials each having a thermal conductivity less than a thermal conductivity of a preceding layer wherein the plurality of successive layers comprises at least a first layer, a second layer, and a third layer in stacked relationship; and (2) matching thermal impedances of the plurality of successive layers from one layer to an adjacent layer in the plurality of successive layers by controlling a volume of one layer relative to an adjacent layer in the plurality of successive layers.

This aspect of the invention may include one or more of the following characteristics, alone or in any reasonable combination. At least one layer in the plurality of successive layers may comprise an insulating material. The insulating material may comprise a thin film. The thin film may be a polyester thin film. Each subsequent layer in the plurality of successive layers in a direction moving away from the source of heat may have a surface area greater than a surface area of a preceding layer.

Another aspect of the present invention is directed to a thermal transformer to conduct heat away from a light emitting diode (LED). The transformer comprises a light emitting diode having a surface area and a plurality of successive layers of materials having dissimilar thermal conductivities. A first layer adjacent the light emitting diode has a first thermal conductivity greater than a second thermal conductivity of a subsequent layer in the plurality of successive layers of materials. A surface area of a final layer in the plurality of successive layers of materials which conducts heat to an environmental barrier substantially greater than the surface area of the light emitting diode. This area is typically greater than 50 times the area of the LED.

Another aspect of the present invention is directed to a thermal transformer for use in removing heat from a light emitting diode. The transformer comprises a surface area of more than 2 square centimeters in size. A lateral thermal resistance is less than a vertical thermal resistance for a 1 square centimeter area including a light emitting diode.

Another aspect of the invention is directed to a thermal transformer for use to remove heat from a light emitting diode wherein a lateral thermal resistance is less than a vertical thermal resistance for a 1 centimeter diameter area including the light emitting diode.

Another aspect of the invention is directed to a package for conducting heat away from a light emitting diode on a circuit board. The package comprises a light emitting diode having a surface area; a first layer of a first metallic material having a surface area in engagement with the surface area of the light emitting diode wherein the surface area of the first layer immediately adjacent to the light emitting diode is at least 8 times the surface area of the light emitting diode; a second layer of a second material spaced from the light emitting diode by the first layer; and a heat sink spaced from the first layer by the second layer. The first layer and the second layer may be produced from different materials, and the material of the first layer may have a higher thermal conductivity than the material of the second layer.

This aspect may further comprise at least three layers of differing materials between the light emitting diode and the heat sink. Each each successive layer moving away from the light emitting diode may have a lower thermal conductivity than a preceding layer. Equally beneficial effects can be obtained if one or more of the layers consists of a lamination of a high conductivity material with a low conductivity material, so that the average conductivity decreases in the same systematic way. At least two layers of different materials may be located between the light emitting diode and a heat sink. The thermal transformer may further comprisie at least three layers of differing materials between the light emitting diode and the heat sink wherein each successive layer away from the light emitting diode has a lower thermal conductivity than a preceding layer.

Another aspect of the present invention is directed to a thermal transformer to conduct heat away from light emitting diodes in which two or more layers exist between a light emitting diode and a heatsink, characterized in that at least two of the layers have a thermal resistance which is the same within 50%, and one of these layers further away from the LED has a higher thermal resistivity than the other at least one layer closer to the light emitting diode.

Another aspect of the present invention is directed to an improvement in a method of transferring heat from a light emitting diode through to a heat sink comprising the step of inserting a plurality of successive layers of thermally conductive materials between the light emitting diode and a final layer of the heat sink wherein a first layer in the plurality of successive layers moving in a direction from the light emitting diode towards the final layer next to the heat sink has a higher thermal conductivity than a subsequent second layer and wherein the heat from the light emitting diode is spread over a greater surface area of the final layer of the heat sink as a result of the plurality of successive layers therebetween.

The improvement may include one or more of the following additional aspects, alone or in any combination. The first layer may have a surface area less than a surface area of the second layer. The plurality of layers may be in a stacked relationship. The first layer may engage the surface area of the second layer. The improvement my further comprise adding an insulating layer between the heat sink and the plurality of successive layers.

Other aspects of the invention are presented in the figures and the detailed description set forth below.

### BRIEF DESCRIPTION OF THE DRAWINGS

To understand the present invention, it will now be described by way of example, with reference to the accompanying drawings in which:

FIG. 1 illustrates a typical prior art approach to thermal management;

FIG. 2 illustrates thermal flow in dissimilar materials with a single heat source;

FIG. 3 illustrates an electrical analog of a heat source with internal thermal impedance and an attached thermal sinking device;

FIG. 4 illustrates a thermal transformer with a series of sequenced thermal impedances;

FIG. 5 is a finite element analysis of a thermal transformer with isotherms and heat flow vectors;

FIG. 6 is a side elevation of a thermal transformer having a thin steel final layer;

FIG. 7 is a plan view of the thermal transformer of FIG. 6;

FIG. 8 is a cross-sectional view showing an unwrapped final layer of the network of FIG. 6;

FIG. 9 is a thermal transformer comprising of concentric rings;

FIG. 10 is a cross-sectional view of the thermal transformer of FIG. 9;

FIG. 11 is a solar application of a thermal transformer;

FIG. 12 is an illustration of an impedance match made of two discrete materials in a composite layer;

FIG. 13 is an illustration of layer averages of unequal-sized layers to layer values for matching;

FIG. 14 is an illustration of layers made of the suspension of one material in another;

FIG. 15 is an illustration of a diffusion thermal impedance matching layer;

FIG. 16 is a schematic representation of a prior art thermal management system;

FIG. 17 is a plot of a distribution of heat flux density just below the fins of the system of FIG. 16;

FIG. 18 is a plot of a temperature distribution along the boundary below the finned areas of the system of FIG. 16;

FIG. 19 is a schematic representation of a thermal transformer of the present invention;

FIG. 20 is a plot of a temperature distribution along a test boundary between layers shown in FIG. 19;

FIG. 21 is a plot of heat densities along a test boundary of the system shown in FIG. 19;

FIG. 22 is a cross section of a thermal transformer of the present invention with insulation attached;

FIG. 23 is a plot of a temperature distribution along a test boundary between layers shown in FIG. 22;

FIG. 24 is a plot of heat densities along a test boundary of the system shown in FIG. 22;

FIG. 25 is a plot of the lateral component of the heat flux at the test boundary of the design of FIG. 22;

FIG. 26 is a three dimensional representation of a thermal transformer of the present invention;

FIG. 27 is an alternative three dimensional representation of a thermal transformer of the present invention;

FIG. 28 is a plan view of a 26 ins diameter thermal transformer.

FIG. 29 is a perspective view of an embodiment of the invention utilizing a gradient layer;

FIG. 30 is a cross-sectional view of the embodiment of FIG. 29 showing a thermal impedance gradient of a fourth layer represented in shading from dark to light to show descending thermal resistivity;

FIG. 31 is a top view of the embodiment of FIG. 29;

FIG. 32 is a perspective view of a third layer of the embodiment of FIG. 30 showing a mass of stainless steel wool on a surface of the third layer prior to setting in a low thermal impedance material such as plaster of Paris;

FIG. 33 is a cross-sectional view of the embodiment of FIG. 29 attached to a power supply; and

FIG. 34 is a cross-sectional view of the embodiment of FIG. 29 attached to a power supply and having a fifth layer of a material having a very low thermal conductivity such as a fiber glass insulation.

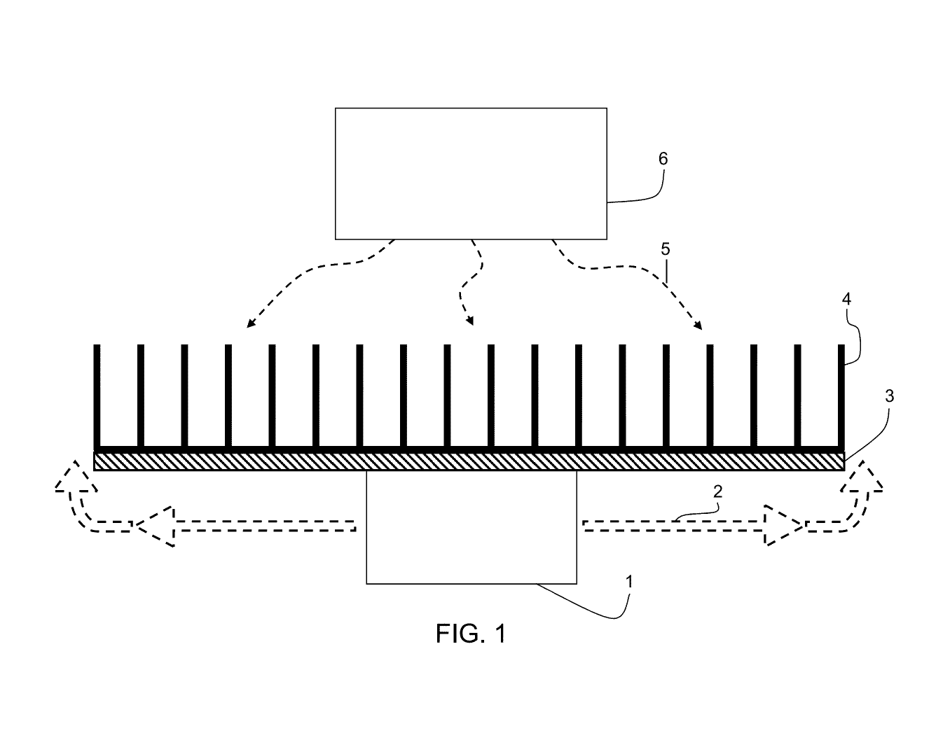

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

This invention relates to the removal of heat from operating devices, such as LEDs which generate waste heat as a byproduct of normal operation. These operating devices require some means to remove this heat for long life, for limiting the temperature for safety, and/or for maintaining an operating temperature within a desired or prescribed range. Broadly speaking, a device of the present invention acts to move heat through primarily conductive means as opposed to radiation or convective means. It transfers the heat from the source to the air or into a building structure. Use of this invention allows heat to be safely and efficiently extracted with low rises in temperature via use of inexpensive, available, and often recyclable materials. In most applications, a device of the present invention can reduce the use of metals in a heat management system by 70 to 90 percent while providing thermal management performance within 99% of that provided by expensive, heavy solid metal structures. The device of the present invention can transform an intense heat flow through a small area into a dilute heat flow over a large area. The resulting dilute heat flow then needs only minor temperature rises to conduct the heat into either the air or into convenient surfaces such as walls or ceilings. Since it eliminates the need for secondary heat removal instruments (e.g. a blower) to provide mass flow for heat removal, a higher level of efficiency is obtained without loss of effectiveness.

The present invention allows heat removal through surfaces and boundaries that normally would be considered thermal non-conductors, and at the same time, keeps the average temperature of the materials of the surfaces and boundaries well below safe levels for human exposure and combustive limits. The invention allows an array of materials—organic, recyclable, low cost, lightweight fibrous and commonplace materials such as clay and glass to be used for high volume applications, such as lighting.

All materials have a propensity for heat conduction. Metals generally have the highest conductivity expressed in Watts per Meter degree Kelvin (W/M-K). Silver (428W/M-K), copper (401W/M-K) and aluminum (171 W/M-K) are widely accepted as efficient conductors. However, silver and copper are infrequently used as prime thermal conductors due to cost constraints. Aluminum has an added benefit of being easily extruded, thus allowing it be quickly formed into designed shapes for optimal heat transfer. Gasses, as a result of their low densities, have some of the lowest thermal conductivity. Air has a thermal conductivity of 0.018 W/M-K. Convection is a more powerful process of transferring heat into air. A square meter of aluminum raised one degree centigrade above ambient can be expected to conduct about 10 W of heat into the air by the process of convection. To provide the same heat flow as one square mm of aluminum requires 9500 mm² of air. The present invention matches thermal impedances to optimize the flow and spreading of heat. The structures and consequences of using such a method are described herein.

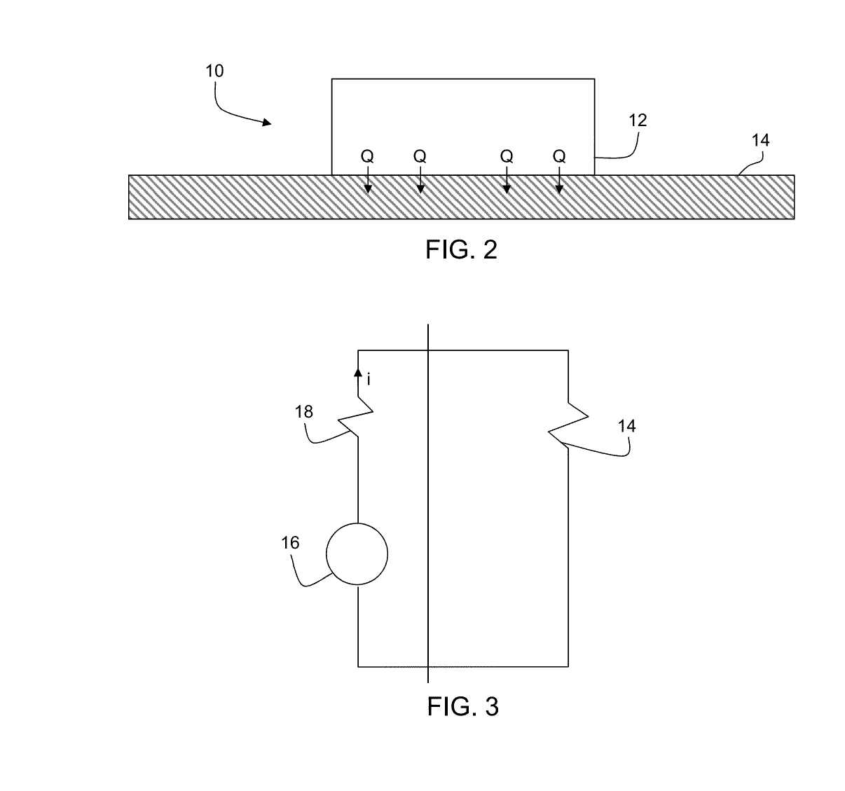

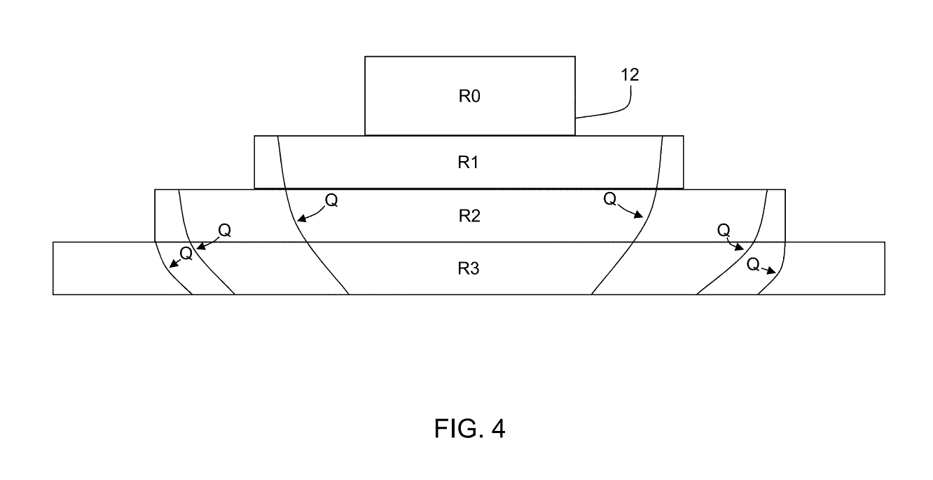

Referring to FIG. 2, a two element thermal system 10 is illustrated. The system 10 includes a heat source 12 embedded in a heat sink 14 of a first material. A heat flow Q is generally dissipated via the heat sink 14. The lowest possible thermal resistance to the ambient can be achieved by having a source of heat 12 in FIG. 2 attached to an extremely large and thick slab of the most conductive metal 14, such as silver. Obviously this is impractically expensive, and even the next best metal, copper, is both expensive, heavy and difficult to fabricate into desirable shapes. Instead, according to the present invention, a relatively thin layer of a conductive material such as copper is used to spread the heat sideways. The heat is then conducted from this downwards into a less expensive and less conductive material such as aluminum, which is also used to spread the heat sideways into an even larger area. Often a third layer of even less expensive but strong material such as steel may be used to spread the heat out over an even larger area. Such an arrangement is depicted in FIG. 4. It is frequently necessary to provide some electrical isolation between the source of heat and the exterior of the heat sink, and so often one of the lower layers is a thin layer of insulating material, as is explained below.

In order that the heat should be passed continuously from one layer to the next, if the layers are of the same thickness, it is desirable that the area of each successive layer should be greater in inverse proportion to its thermal conductivity. In this manner, a uniform temperature progression is obtained through the transformer. The layer thicknesses can be adjusted also to achieve this effect. The area of the first highly conductive layer is advantageously more than eight times the area of the LED itself.

In FIG. 4, a structure having progressively lower thermal conductivity and progressively increasing areas with thermal resistances R0,R1,R2,R3 is depicted. Each layer has roughly the same thermal impedance:

R0=R1=R2=R3 . . . R∞ (1)

If the thermal conductivities of the layers are x_{1,} x₂, etc., and the corresponding areas are A₁, A₂, etc., then for each layer to have the same thermal resistance:

$$\frac{{x}_{1}}{{x}_{2}} = \frac{{A}_{2}}{{A}_{1}} \qquad ( 2 )$$

This will lead to an equal temperature drop across each layer. For example, if:

x₁=171

x₂=43

Then for equal heat flow at equal temperature difference, if:

$${A}_{1} = 100 {mm}^{2}$$

$$\frac{171}{43} = \frac{{A}_{2}}{{A}_{1}}$$

$${A}_{2} = \frac{171}{43} * 100 {mm}^{2}$$

$${A}_{2} \approx 400 {mm}^{2}$$

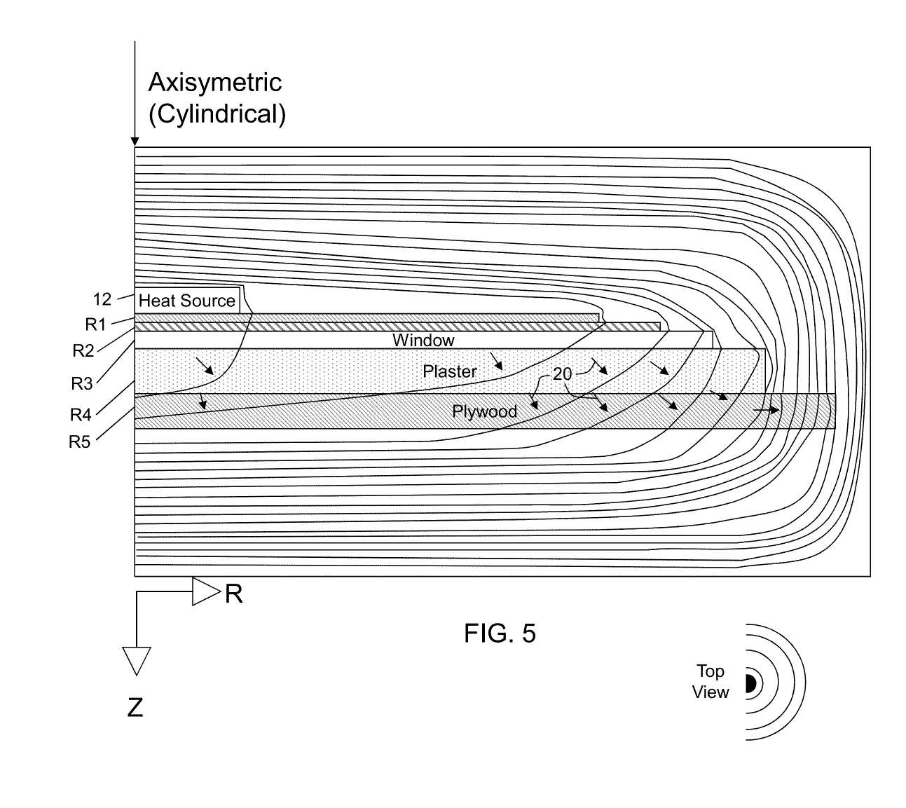

FIG. 5 shows a thermal transformer in a cylindrical coordinate system. The areas of the layers are proportioned according to equation (2). In this framework, the heat is vectored into the Z-axis and the radial-axis. The local heat flow vectors are labeled 20. Each isothermal boundary is a temperature change of 0.011 degrees Kelvin. It can be seen from the average temperature of each layer that there is a very uniform distribution of temperature. The heat source layer is 319.8° K., the next layer 318.5° K., the next 317.8° K. and the last layer 313.38° K. The layers of materials in this example R1,R2,R3,R4,R5 are aluminum, steel, glass, plaster (or drywall), and plywood, respectively.

The average temperature demonstrates that each layer has moved the temperature gradient to a nearly uniform-radial-distribution over each subsequent layer and, therefore, fully utilizes the available areas for heat transport.

The design is critical in the first layers and less critical in areas away from the heat source 12. This allows designs to be fabricated on large sheets of the least costly materials while not significantly impacting the overall performance. The first layers provide strong vectoring of heat flow and must not be smaller than prescribed by the invention design criteria. Once the heat has been distributed over a relatively large area, the final layers are less important and can have deviations larger than design without significant impact. However adding extra material does not significantly change the operational outcome. This has practical import to the extent the invention is not violated by adding additional materials outside the local boundaries of primary heat flow which could be viewed by some as circumventing the invention. The final flow of heat is so dilute that changes in the final layers only produce inconsequential changes in temperature. This is important in the context, for example, of dirt accumulating on a surface that was supposed to provide cooling by convection.

A key concept in understanding this invention is that of thermal resistance. If a solid object has two surfaces, which can be kept or observed to be at fixed temperatures, then the thermal resistance R is the temperature difference per Watt of heat flowing. Usually thermal resistance R is in ° C. per Watt. For certain standard shapes, there are well known formulae for thermal resistance. For example, for a cylinder of cross sectional area A with length t made out of material with a thermal conductivity k, the thermal resistance from end to end is:

$$R = \frac{t}{kA} \qquad ( 3 )$$

If RMKS units are used, then A is in square meters, t is in meters and k is in W/mK, where K is ° K. temperature difference. This is useful to compute the vertical thermal resistance of a layer of a thermal transformer having known dimensions and thermal conductivity.

Near the heat source, which is usually an LED, heat is being spread sideways from the heat source. This spreading thermal resistance is an important concept. Ignoring for the moment the heat being dissipated vertically, if the inner radius of a layer in contact with a heat source is r₁ and the outer radius which we are considering is r₂, then the lateral spreading thermal resistance is:

$$\frac{ln \frac{{r}_{2}}{{r}_{1}}}{2 π kt} \qquad ( 4 )$$

For a thermal transformer to work well, it is necessary that for the region close to the heat source, the lateral thermal spreading resistance is less than the vertical thermal spreading resistance. For example in the case of a light emitting diode heat source,equation (3) can be used to compute the vertical thermal resistance downwards through the top layer of metal in contact with the LED and through each subsequent layer underneath to the surface which interfaces with the environment. Since this vertical thermal resistance decreases with the increasing radius of the cyclinder, then the larger the diameter of the cylinder considered the smaller this resistance will be. For a circular layer of metal immediately under the light emitting diode (LED) equation (4) can be used to compute a lateral spreading resistance for heat being transferred sideways to the perimeter of this circular layer. If the subsequent layers are less conductive, which is usually the case, then the contribution to the thermal resistance from the lower layers can be conveniently disregarded. As the outer radius of this circular region increases, this lateral spreading resistance increases. Hence it is that when the respective vertical and lateral thermal resistances are computed for an increasing radius around an LED, the lateral spreading resistance starts off small and becomes larger, while the vertical spreading resistance starts off large and becomes smaller. Eventually the lateral spreading resistance will become larger than the vertical spreading rsistance. Thermal transformers constructed according to this invention have relatively lower lateral spreading resistance compared to the vertical spreading resistance. A thermal transformer according to this invention can be characterized by having a lateral thermal resistance which is less than the vertical thermal resistance for a one half cm radius area around the LED. This condition ensures that the heat from the heat source initially flows sideways rather than downwards. It can be achieved by having the top layer next to the heat source be of highly thermally conductive material such as copper and having the adjacent layer to be markedly less thermally conductive, for example either aluminum or a required electrical insulator. The layer which is adjacent to the LED is advantageously of significantly greater area than the area of the LED itself, such as more than 8 times the area. These properties can be used as criteria to recognize a thermal transformer according to the present invention.

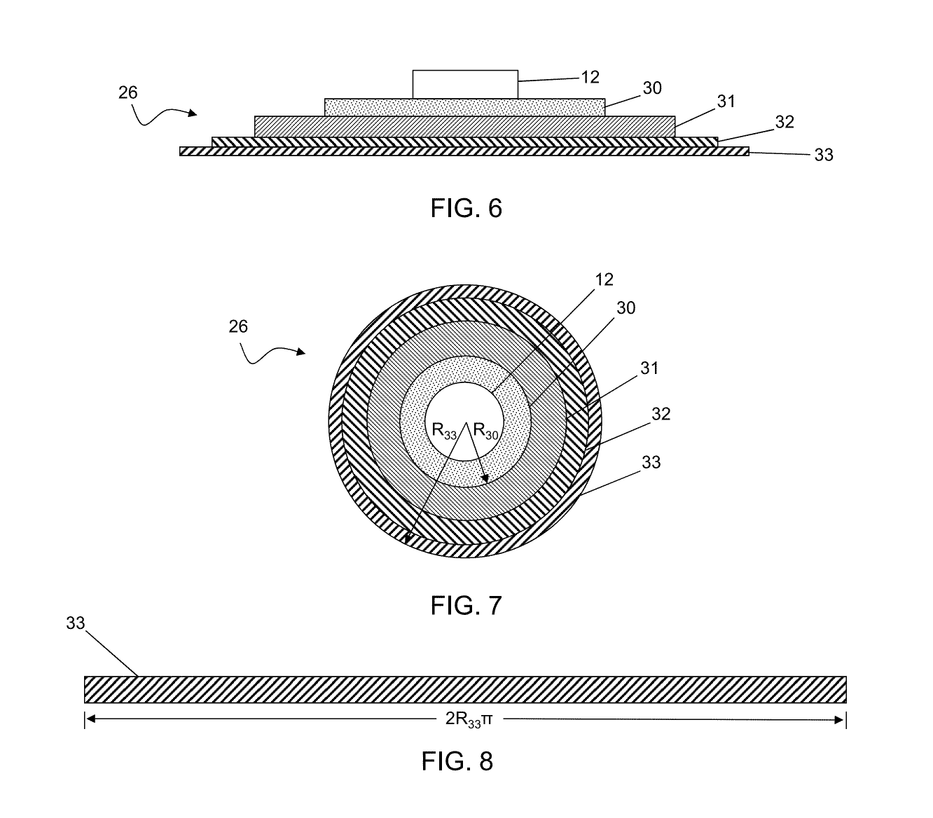

The thermal transformer of the present invention that has been described converts an intense heat flux over a small area into a dilute heat flux over a large area. For example in FIG. 6 the area of the LED 12 might be between 1 and 10 square mm, depending on the power level of the LED being considered. The subsequent layers are increasingly larger until the final layer is large enough to have a thermal resistance to the ambient which is low enough to dissipate the power being used without excessive temperature rise. More precisely, it has been found through experimentation that in general the most beneficial thermal transformer action is achieved if the thermal resistance of each layer (lateral and vertical acting in parallel) to the next layer is about the same to within about a factor of two. This produces a relatively even temperature gradient through the transformer. By way of example, if the area of the LED was 10 square mm then the area of the final interface to the environment might advantageously be more than 500 square mm. It is tempting to attach huge heatsinks directly to an LED; however, without the intermediate layers of heat spreading material to move the heat sideways, the benefit of the huge sink is unlikely to be realized. The simultaneous presence of a 50:1 or greater ratio between the LED area and the area of the final interface to the environment together with the presence of one or more intermediate layers is a characteristic which can be used to recognize an embodiment of the invention. By analogy, with electrical circuitry, it is as if an impedance transformation has been effected. Following the analogy further, in the following sections, the layers of the thermal transformer are sometimes referred to as a matching network. The matching network has many possible variations that can provide good thermal matching to thin layers, such as steel furniture. The steel outside of the furniture is typically between 5 and 10 thousandths of an inch thick. In FIG. 6, a thermal transformer 26 is a typical design for a thin-wall steel configuration. The thermal transformer comprises multiple layers 30,31,32,33. The first layer 30 is generally aluminum. The final layer 33 is the steel layer and by itself has a high thermal impedance looking from the center of the heat source outwardly. (See FIG. 7). In order to meet commonplace safety requirements, it is frequently desirable that one of the elements of the thermal transformer should be an insulating layer. This can provide electrical isolation between the heat source and the steel furniture which has to be grounded. If the insulation layer, for example Mylar® film (Mylar® is a registered trademark of E.I. du Pont de Nemours and Company Corporation), is thin and is inserted well down in the stack, for example next to the steel, then its thermal resistance which is added can be negligible.

FIGS. 6 and 7 show two common materials, e.g. brass and a thin polyester Mylar® film, in layers 31,32 before the final steel layer 33. The decreasing thermal conductivity of each subsequent layer forces the heat to flow out radially so that at the final layer the heat is being transferred uniformly.

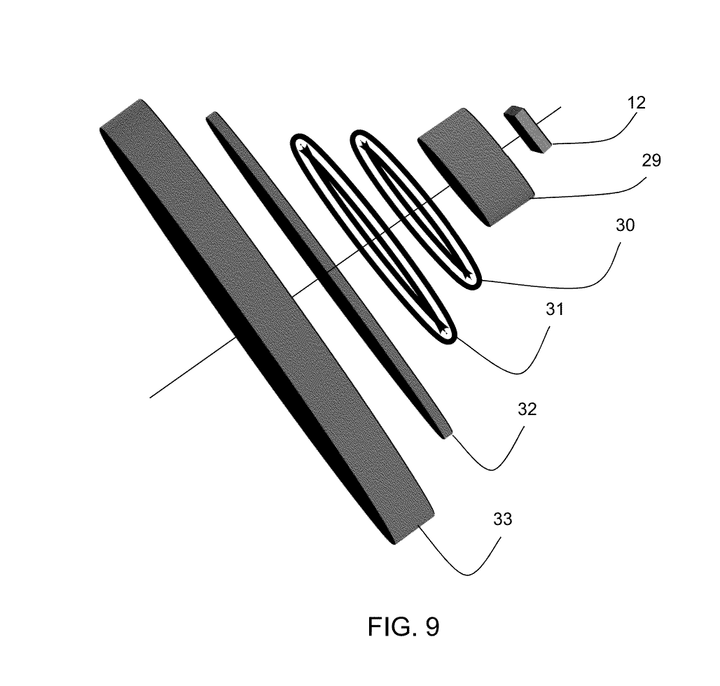

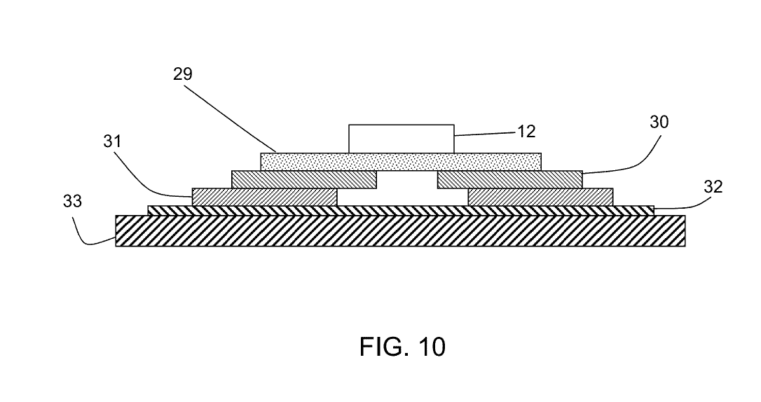

It is interesting to observe that since the temperatures are uniform across each layer and the area in each successive annulus is proportional to the square of the radius, then the inner portions of the successive layers contribute little. They could be omitted, as shown in FIG. 9 and FIG. 10, without a major impact upon the thermal transformer operation. For this reason, the thermal transformer 26 could be a series of concentric rings that are stacked as shown in FIG. 9.

In FIG. 9, the stack starts with a first thermal layer 29. The first layer 29 is typically a solid material, as the source is typically located in the center of the initial layer, for example solid copper. The next layers 30,31 are concentric rings followed by a layer 32 of polyester film, e.g. Mylar® film, and the final layer 33, e.g. a thin steel layer. It should be noted that although this provides for the minimum use of materials, it could be all solid without loss of effectiveness. See also FIG. 10.

Broadly speaking, the invention is not limited to any particular physical shape or material dimension. However, one of ordinary skill would readily understand that in each geometry, where the invention is applied, the sequence of material thermal/impedance transitions, to meet the geometric condition, could be much different than described. However, the transitions will substantially be sequenced in ascending or descending order of thermal resistivity. In particular it is not necessary for the areas of the successive layers to be in a sequence of increasing size. Additional area can be added to early layers without affecting the performance of the thermal transformer.

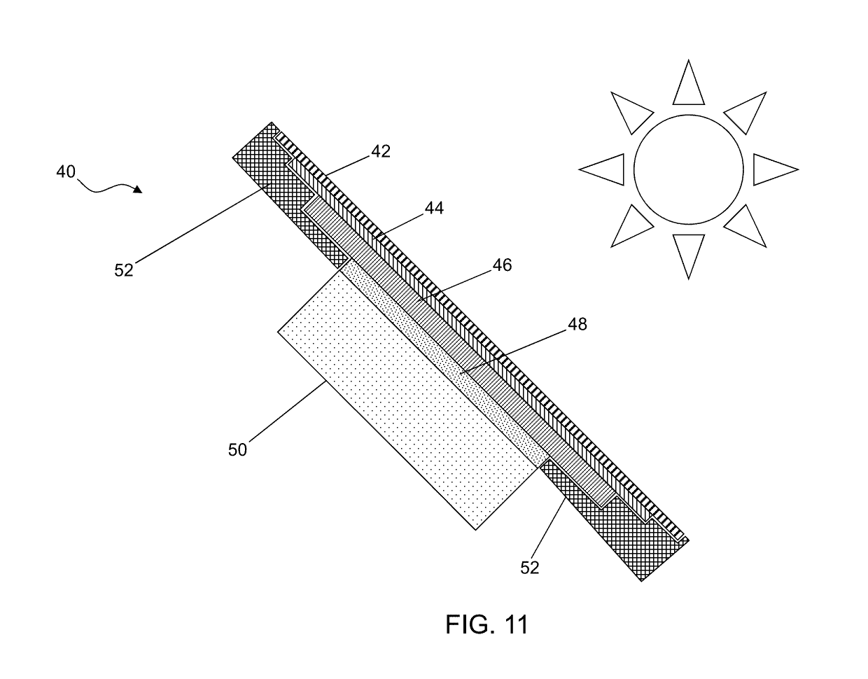

It is important to remember that the thermal transformer is bi-directional and has solar applications for non-optical collection and redirection of solar energy. FIG. 11 shows the use of a thermal network 40 collecting a diffuse thermal energy and, through a thermal transformer, concentrating the thermal flow to a smaller area where it can be effectively collected. The thermal transformer 40 is composed of, but not limited to, a glass layer 42, a steel layer 44, an aluminum layer 46, and a final copper layer 48 to which a heat exchanger 50 is attached. To prevent heat loss to the air, a layer of insulation 52 is provided opposite the glass. For best absorption of the visible solar energies, a second steel layer 44 just below a glass layer 42 would be black in color. The glass layer 42 traps the infrared energies, giving the invention a broadband absorption characteristic unlike solar voltaic cells which are much narrower band collectors.

The objective of using multiple layers in the thermal transformer is to achieve economy, ease of manufacture and structural rigidity along with electrical isolation. If thermal conductivity were the only objective, then the best conduction of heat from a heat source to the air would be achieved using a massive plate of high conductivity silver. However, silver is extremely expensive and even copper is expensive, hard to machine, and lacking in rigidity. As explained above, a relatively thin layer of copper close to the heat source serves the desired purpose of transmitting the heat out sideways to cover a larger area. Then, a larger layer of cheap but stronger aluminum carries the heat out farther and finally transmits it, for example, through a layer of Mylar® film and into a layer of inexpensive but structurally rigid steel. Many other different materials can be used to achieve the same effect.

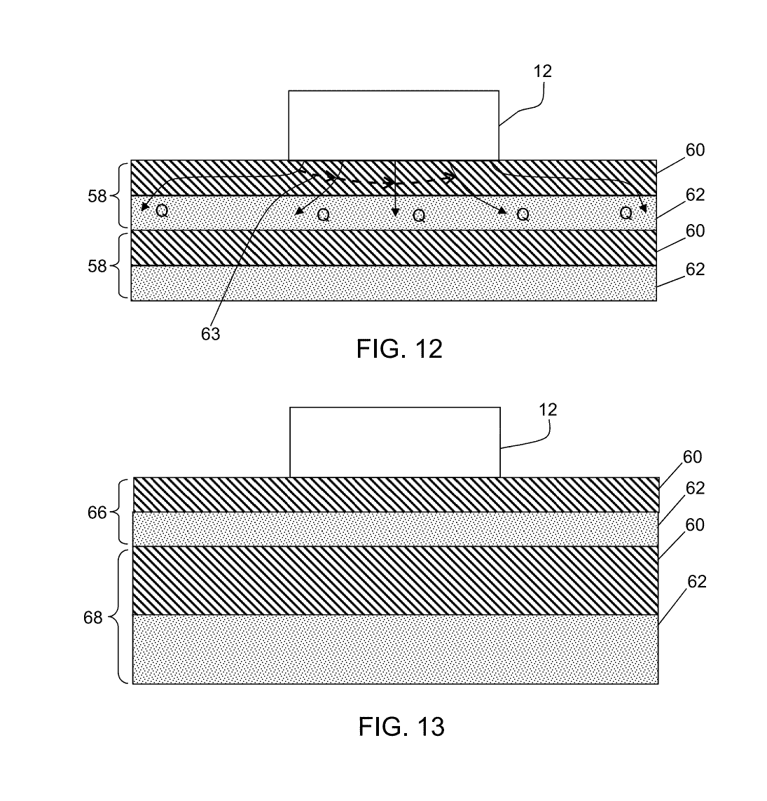

The overall result of having steadily increasing thermal resistivity in order to force the heat flow sideways can also be achieved by stacking composite layers which have the overall effect of steadily increasing resistivity, even though there may be thin highly conductive layers inside the composities. This can be achieved as shown in FIG. 12. The figure shows a composite layer 58 formed from two discrete materials, a metallic layer 60, e.g. copper 60, and a second layer 62, preferably a temperature resistant, flame retardant nylon, such as Nomex® material (Nomex® is a registered trademark of E. I. du Pont de Nemours and Company Corporation), or a fiber paper. Each copper 60/Nomex® 62 composite layer 58 creates an averaged thermal impedance to the heat source 12. It should be noted that, in FIG. 12, the layers are shown equal thickness, width and length. This is for explanation purposes only and not a requirement of inventive method. Each composite layered form 58, having alternating layers of high and low thermal conductivity encourages the lateral flow of heat required for a thermal transformer. Successive composite layers can be designed to have overall average thermal resistivity which increases thus further forcing the sideways flow of heat.

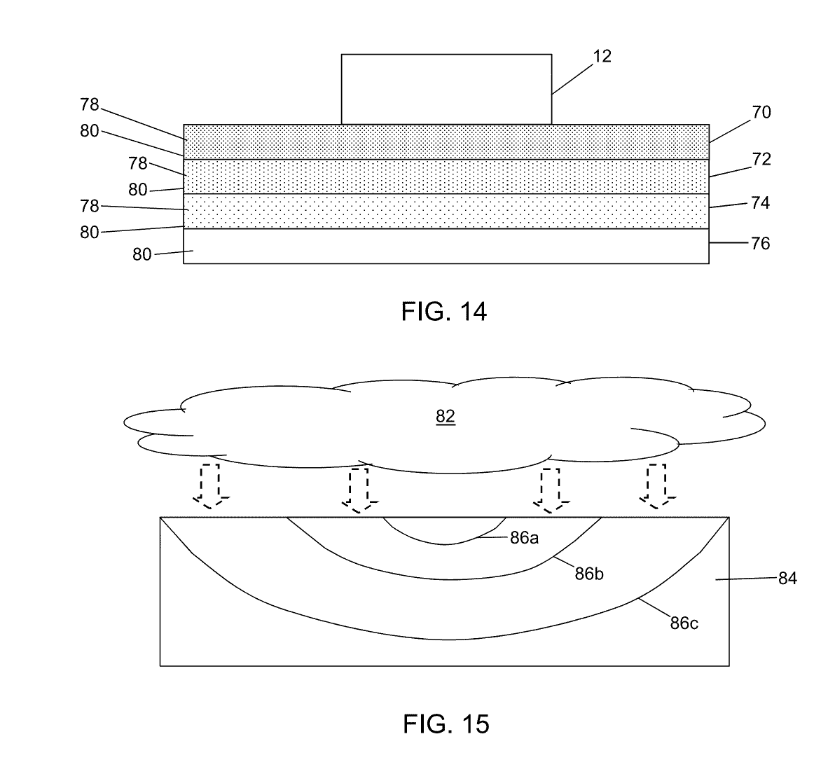

An additional structural variation in which the heat flow is vectored sideways while using only a minimum of inexpensive high conductivity materials is to have a graduated suspension of a high thermal conductivity material in another of lower thermal conductivity. FIG. 14 illustrates a plurality of layers, e.g. four layers 70,72,74,76 where a material 78, e.g. a conductor, such as a metal like copper or aluminum, is interspersed in clay or plastic 80. Although shown as layers it could be a graduated distribution over a clay block. The dot density in FIG. 14 represents the level of (or ratio) of high conductivity to low conductivity such that each subsequent layer has a decreasing ratio of high conductivity material 78 to low conductivity material as the layers move away from the heat source 12. Showing it in discrete form allows use of the graduated layer explanation previously described. The transformer is shown as a cylindrical stack although the outer parts of the upper layers could be removed with little effect.

Referring to FIG. 15, an additional variation is to use the principle of diffusion to diffuse a higher thermal conductivity material 82 (e.g. a metal) into a lower thermal conductivity material 84 (e.g. a ceramic). This would generate a continuum of thermal graduations 86a, 86b, 86c and the most ideal thermal matching. If it could be fabricated economically, such a structure would comprise an excellent thermal transformer, providing expensive high conductivity around the heat source and using low cost material of lower conductivity further away from it.

The present invention immediately finds application in light emitting diode lighting systems. It allows the ordinary surfaces—walls, floors, ceiling tiles, concrete walls to become viable heat sinks for LED lighting. It is purely passive and uses the most ordinary materials. The consequence of having extremely dilute but uniform heat flows over a large area provides counter-intuitive characteristics such as when 60 watts of LEDs are mounted and operating on a half inch thick piece of paperboard of two foot square (a ceiling tile) positioned horizontally, the temperature equilibrates to design level. When fiberglass insulation is placed on top, the temperature hardly rises.

### EXAMPLE

One practical application of the invention is removing heat from an LED lighting system. The described technique can be implemented to decrease the application limitations of LEDs while reducing the carbon footprint associated with the heavy use of metals such as copper, aluminum and steel. Metal usage can be reduced by 80% and substituted with common recyclable/degradable materials such as wood, concrete and plastics. This is accomplished with a thermal transformer that transitions the heat from the source to subsequent intermediate layers that provide rapid dispersal of the heat to background materials and structures such as walls, floors, ceilings and ceiling tiles. This allows LEDs to be deployed in a rational, ecological manner with a much smaller environmental impact.

All materials can conduct heat, some much better than others. Classically only very high thermally conductive materials, e.g. copper and aluminum are used in the construction of heat removal devices. However, this approach albeit functional does not fill the need of form and function needed to allow LEDs to come to highest level of utilization in most lighting applications.

To gain a full perspective of the approach, it is best to understand the materials that could be involved or encountered in a user environment. Table 1 gives a brief sketch of some of those materials and an approximation of their thermal conductivity.

TABLE 1
Thermal Conductance of Commonly Encountered Materials

| Material type | Watts/m²K |
|---|---|
| Diamond | 1000 |
| Silver | 429 |
| Copper | 401 |
| Aluminum | 171 |
| Stainless Steel | 14 |
| Concrete | 1-1.1 |
| Window glass | .84 |
| Plastic | .5 |
| Plaster | .5 |
| Human skin | .37 |
| Maple Wood | .17 |
| Fiberglass | .035 |
| Air | .014 |

From Table 1 several observations can be made. The most obvious is that all heat sinks should be fabricated from diamonds—albeit expensive—and could only add to the glamour of LED lighting. At a more practical level, the materials commonly used are aluminum and air. The thermal conductance of aluminum and air differ by a ratio of more than 12,000:1. In order to transfer heat from highly conductive aluminum to relatively high thermal resistance air, it is necessary to spread the heat sideways to a huge extent so that the concentrated heat flux is converted into a dilute one. The term impedance matching is used as generic term for the matching process.

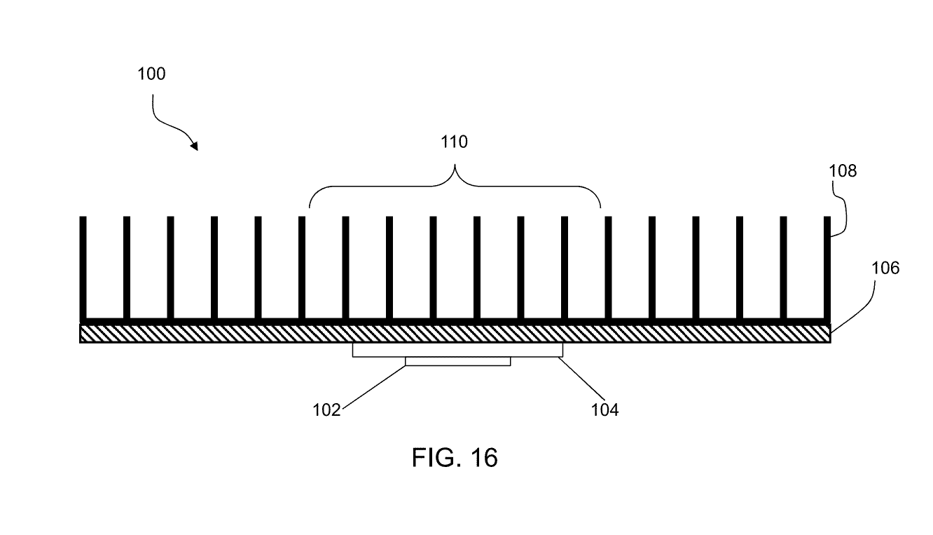

FIG. 16 is a schematic diagram representing a lighting system 100 having a string of LEDs 102. The LEDs 102 are mounted on a copper bar 104 and attached to an aluminum heat sink 106 having a plurality of fins 108. The LEDs have a total heat dissipation of 12 watts, and the dimensions of the system 100 are 3.35 ins×5.15 ins×2 ins. Plotting the temperatures in the system 100 showed that the highest drop in temperature occurred at the air/fin interface. This system 100 was highly ineffective at moving the heat from the operating device. In this example, with 12 watts and an ambient of 300° K. with natural convection, the temperature rise in the center of the copper bar 104/LED 102 interface boundary was 15° K. to 315° K. Any obstruction that would interfere with air movement would be catastrophic to operating this device 100.

The heat sink occupied a volume of 34 cubic inches and 400 grams. The volumetric requirements that the structure needed to occupy for adequate operation in the less than optimal orientation shown, was at least twice its physical displacement needed to provide space enough for establishment of real convection.

The physical structure illustrated in FIG. 16 was ineffective at moving the heat from its target thermal load because it was hard for the heat to flow sideways into the outer areas of the heat sink 106 of the fin header. It was clear that the structure could move more heat if it were distributed uniformly over the header region 106.

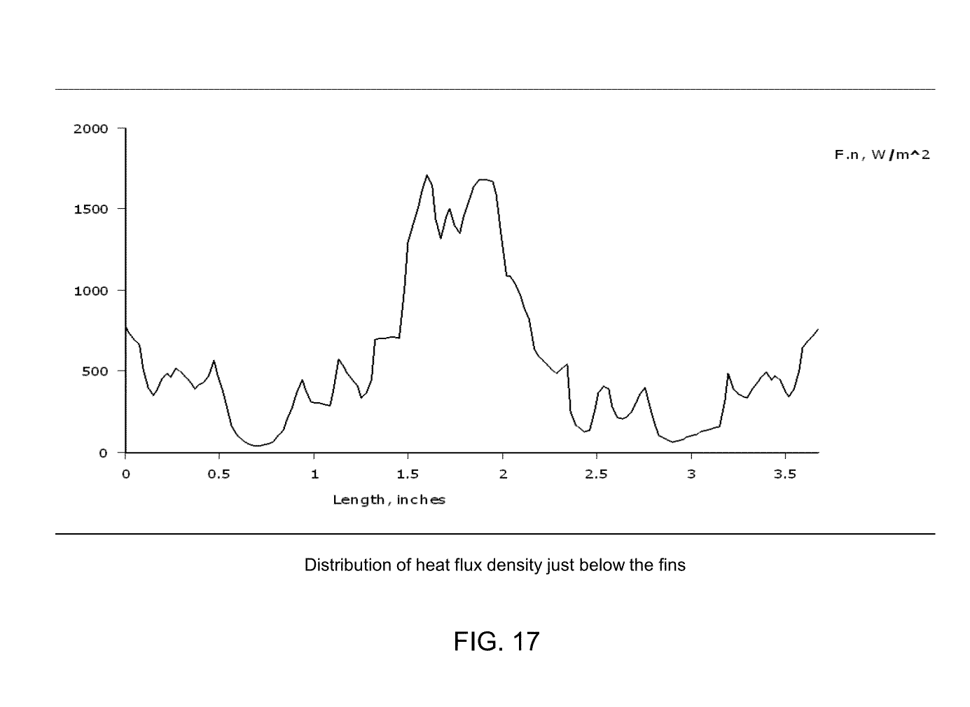

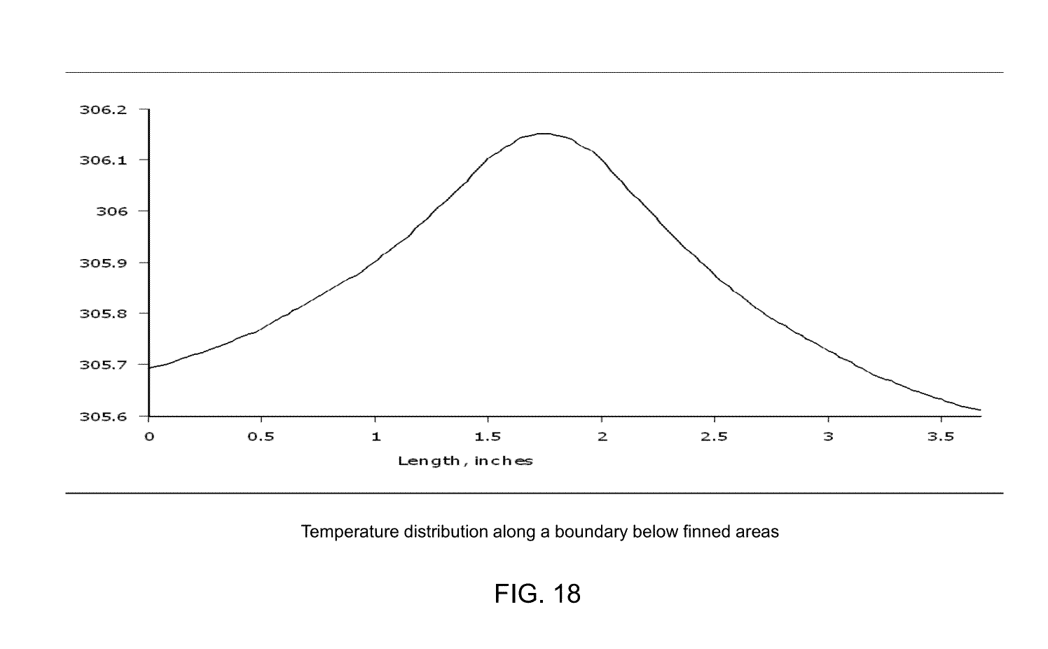

FIG. 17 is a plot of the copper to heat sink flux along a line between the copper 104 and the heat sink 106. It is clear that the heat flux density bunching in the center focuses the heat flow to the fins 108 immediately above the LED bar 104. It is apparent that the center 30% is handling 80% of the thermal loading in the heat sink (see also FIG. 16, reference 110). Thus, it is clear more metal does not always equate to cooler LEDs. FIG. 18 shows the corresponding temperature distribution.

The above discussion now leads to the concept of vectored thermal flow. Vectoring of the heat flow is used to distribute the heat flux, as needed to effectively move the heat away from the operating device. This means moving the heat sideways in order to deliver it to the areas that can sink the heat away.

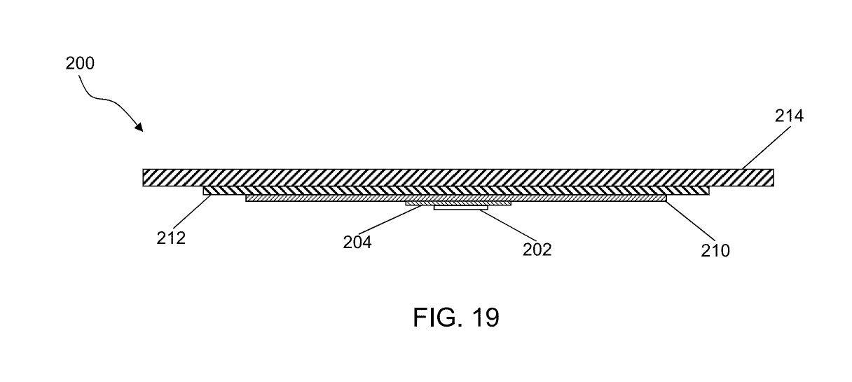

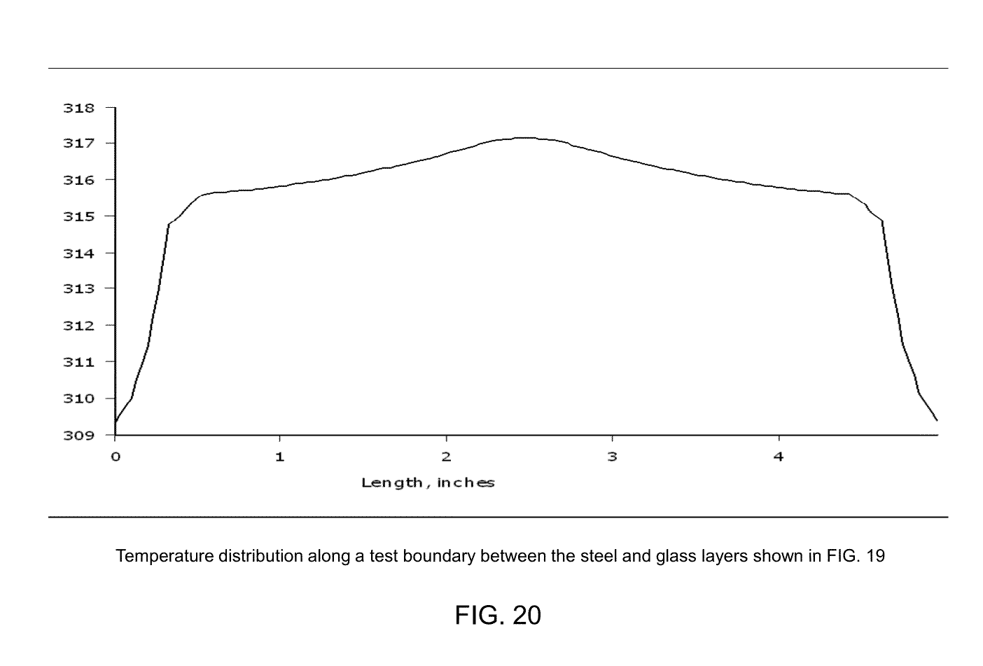

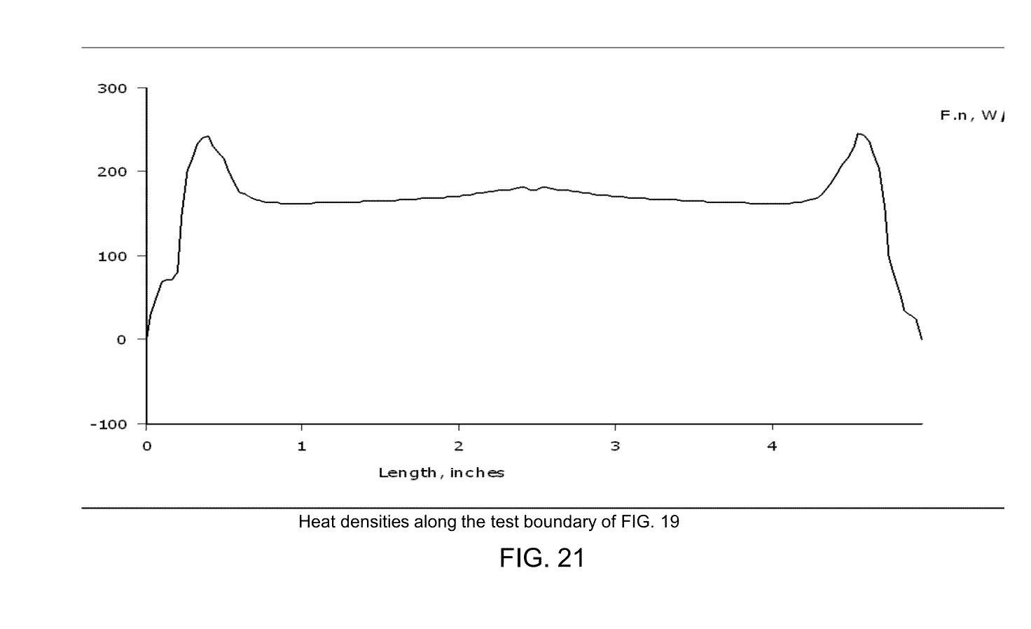

FIG. 19 shows the physical structure of a thermal transformer 200 designed according to the principles of the present invention. The thermal transformer 200 is composed of a plurality of layers of materials of descending thermal conductance. Although superb heat spreading could be achieved if the whole structure were made out of solid silver, in this example comparable temperatures and heat removal are achieved using inexpensive, easily worked materials. The LED bar is the same as described earlier with a string of LEDs 202 on a layer of copper 204 and has the same thermal loading of about 12 Watts for a thermal density of 2200 W/m². The dimensions were 5 ins×5.15 ins×0.170 ins for a volume of 4.4 in³ and a weight of 200 grams.

The layers in this example were layer one 204 of copper 0.02 ins, layer two 210 of aluminum at 0.03 ins, layer three 212 of 347 stainless steel at 0.04 ins, and layer four 214 of glass at 0.08 ins as the final stage material. The performance of this thermal transfomer can be seen in FIGS. 20 and 21. The thermal distribution over the structure 200 had a thermal rise above ambient of 16° K. for a temperature of 316° K. As compared to the typical finned heat sink arrangement, the system 200 is as effective at ⅙ the volume and a fraction of the cost.

A closer look at the simulation output of the heat densities revealed a strong sideways heat flow out from the LEDs. The peak heat flux densities were lower in the second layer 210 with much less variation—a more uniform distribution—of heat flux density. By the third layer 212, the upward heat flux densities were nearly uniform.

FIG. 20 shows the temperature distribution of the network 200 along a test boundary between steel layer three 212 and glass layer four 214. As compared with the finned heat sink example, the distribution shows a uniform temperature rise over a very broad region of the network body. This is a requirement for optimal thermal flow. The nearly uniform heat flux across the boundary can be seen in FIG. 21. The dog ear shapes at the two ends are associated with the glass layer being able to dissipate heat from two surfaces—top and bottom, in its outer annulus.

Temperature equalization takes place in each layer because the next layer has lower thermal conductivity. With the right combination of layers, materials, and layer thicknesses, thermal transformers can be designed so that the heat flow is so diluted (spread out) that ordinary structures, e.g. walls, floors, ceiling, and tiles can be used as heat sinks without using large amounts of expensive materials.

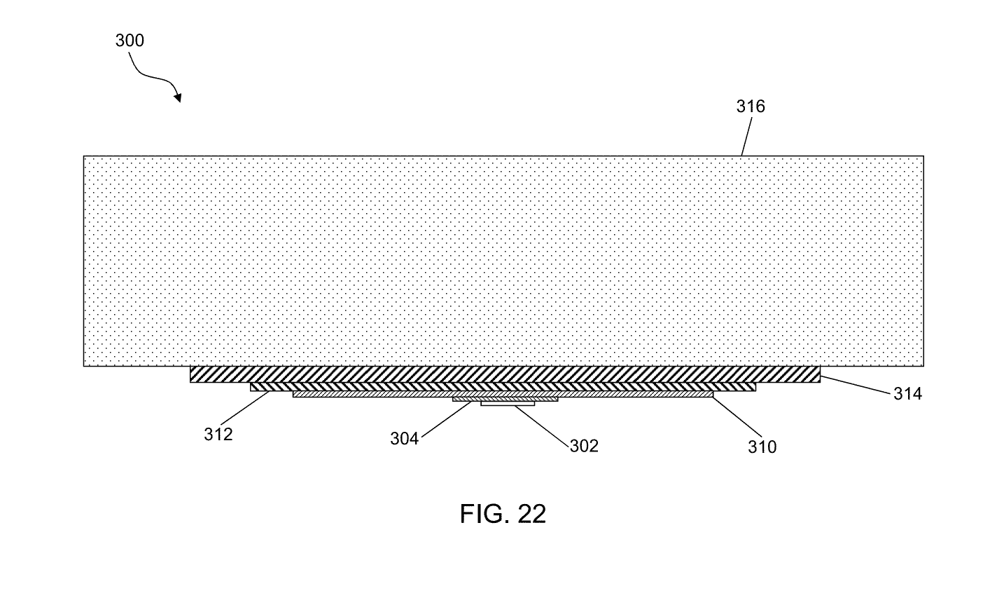

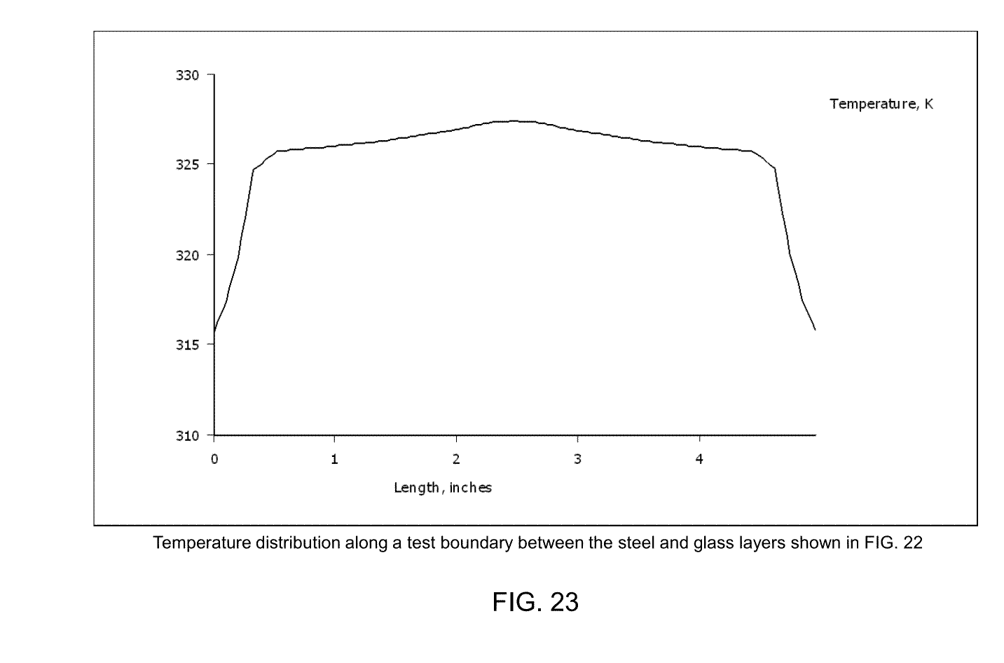

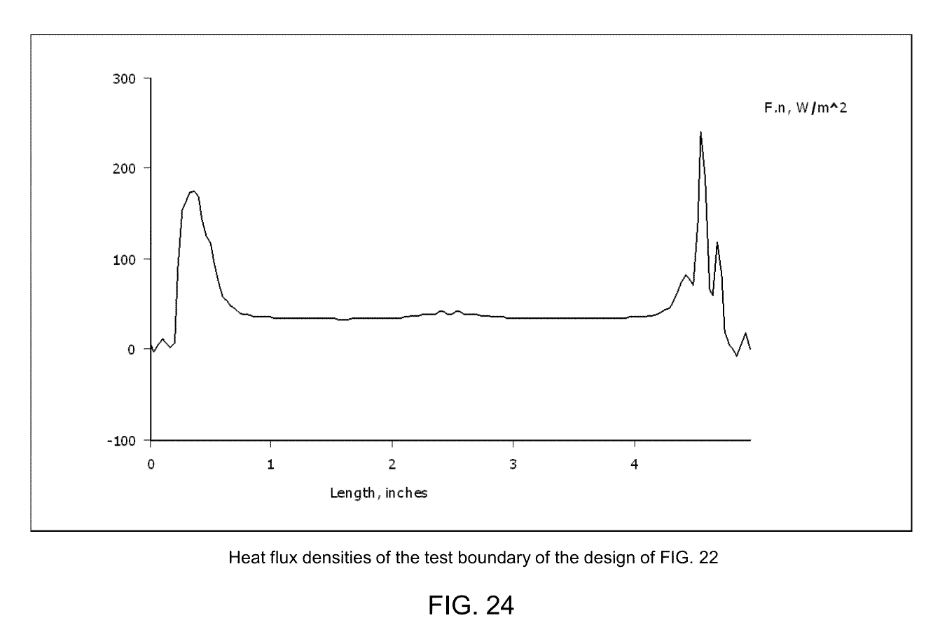

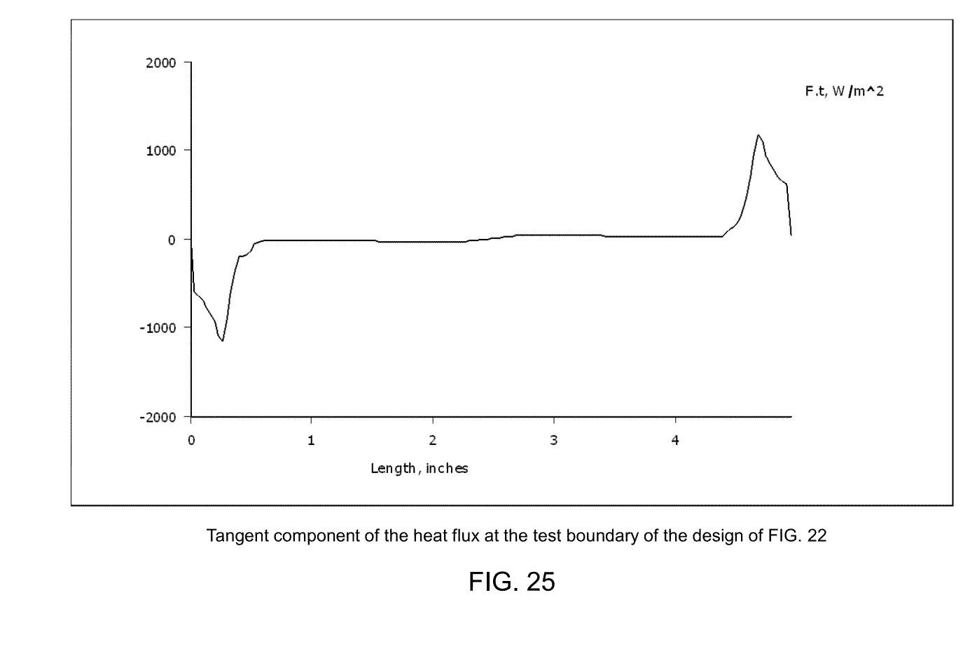

This very dilute heat flow can cause the nature of the final surface to become very non critical and capable of tolerating large amounts of dirt and contamination without much affect. To demonstrate, a second design 300 of the thermal transformer is shown in FIG. 22. The only difference was a fifth layer 316 consisting of a 1.0ins layer of fiberglass insulation added to the top. Intuition would lead to the conclusion that the heat would be trapped by the insulation layer 316. In reality, as seen in Table 1, fiberglass insulation is a better conductor of heat than air by a factor of three. The effect of the insulation did not radically change the overall performance of the thermal transformer 300. In this example, there was an additional 8° K. rise over the previous un-insulated example (compare FIG. 23 with FIG. 20). Also, the normal heat flux vector, FIG. 24, shows a seeming reduction; however, the tangential component, FIG. 25, now comes into play. (Heat flows to the right are shown as positive, heat flows to the left are negative.) The effect of the insulation causes the thermal transformer to redirect more of the heat sideways to maximize flow.

Other designs have been tested that can properly heat sink 60 Watts using 0.2 ins thick thermal transfomers attached directly to cellulose ceiling tiles. Concrete, woods, plastic and many other materials classically considered thermal impediments now can be configured into effective heat removal entities thus reducing the need for metals in heat sinking applications by 80% or more.

### EXAMPLE

Three devices were produced for comparison purposes. Two devices were produced according to conventional commercially available thermal dissipation methods, and one device was built according as a thermal impedance matching transformer according to the present invention. All three devices had equivalent thermal performance. One of the conventional devices was a finned aluminum dissipation device. It weighed 497 grams and was 5 ins×5 ins×1.2 ins. It was designed to transfer heat to the surrounding air. For proper free air operation the fins needed to be positioned vertically and clearance had to be at least 1.2 ins around the back side. This made the use of this very difficult with many fixture designs.

A far more complex compound air heat sink device with a copper thermal spreader to embedded heat pipes distributing the heat was also built. It weighed 461 grams and was 3.4 ins×2.7 ins×2.5 ins. This device also needed proper clearances to allow for proper thermal dissipation, thus suffering the same drawbacks as the simple finned device.

The third device was a thermal transformer of the present invention. It weighed 261 grams and was 4 ins×7 ins by 0.2 ins. There were no limits on front side clearance; it was designed to transfer heat to a wallboard or tabletop, and so it needed to be in contact with wallboard or table top.

A test was carried out to measure the operation of each unit. The test allowed for free air operation with two 13 watt LEDs operating at rated power until thermal equilibration. The first device has multiple orientations of which only one will give design performance. Two common orientations were applied in this test, fins vertical and then horizontal. The proper placement is fin vertical to allow convective air currents to pass through the fins and remove heat. The fins horizontal mode destroys effective air convection through the fins and is less effective.

The configuration of the first prior art unit was with fins vertical and one LED above the other thus creating a different temperature in the two LEDs. At 25° C. ambient and 26 watts power in the fins vertical configuration, the lower LED achieved 71° C. and the upper LED achieved 74° C. Tests with fins horizontal, which is technically a wrong configuration, negated the differential temperature, and the LEDs reached equilibrium at 77° C.

It should be noted that the above test allowed clearances around the heat sink that would not be allowed in a real world application. The sheer volume of the heat sink is 30 in³. To provide for proper free air convective current a 50% to 100% additional volume is needed to properly utilize this device.

The horizontal orientation had the same limitations; however, the convective efficiency was reduced making it not much better than a flat aluminum plate.

If this type of thermal management is utilized fixture flexibility is comprised as to its orientation, and the required clearances will limit its aesthetic appeal.

Similar testing was carried out on the second prior art unit, which was characterized as a compound heat sink. This is because of the use of multiple materials such as: a copper header, an aluminum base, heat pipes, and fabricated fins. At 26 Watts and 25° C. ambient the equilibrium LED temperature was 79.3° C. The unit weighed 461 grams with a volume of 23 in³. While there were small savings in volume and weight, they were vastly offset by the cost of such a device.

The thermal impedance transformer of the present invention was tested in a horizontal position. In this position, the heat flow is nearly all conductive sinking to the support surface on which it rests, in this case a table top. Convection is a very small part of the heat flow and thus the device could be completely enclosed without affecting the equilibrated temperature. At 26 Watts, 25° C. ambient, the final temperature was 79.0° C. The unit weighed 261 grams, 130 grams of which was window glass, 31 grams were copper, 60 grams were steel and 40 grams were aluminum. The volume was 5.6 in³, and the device did not require additional space for proper operation.

Compared to the simple finned aluminum device there was a 47% reduction in weight and an 82% reduction in volume. Compared to the compound device there was a 44% weight improvement and 76% reduction in volume. The thermal transformer structure was the least expensive in terms of the materials used.

The only limitation in applying the thermal transformer was that it needed to be in contact with wallboard, wood, thick paper or concrete.

### EXAMPLE

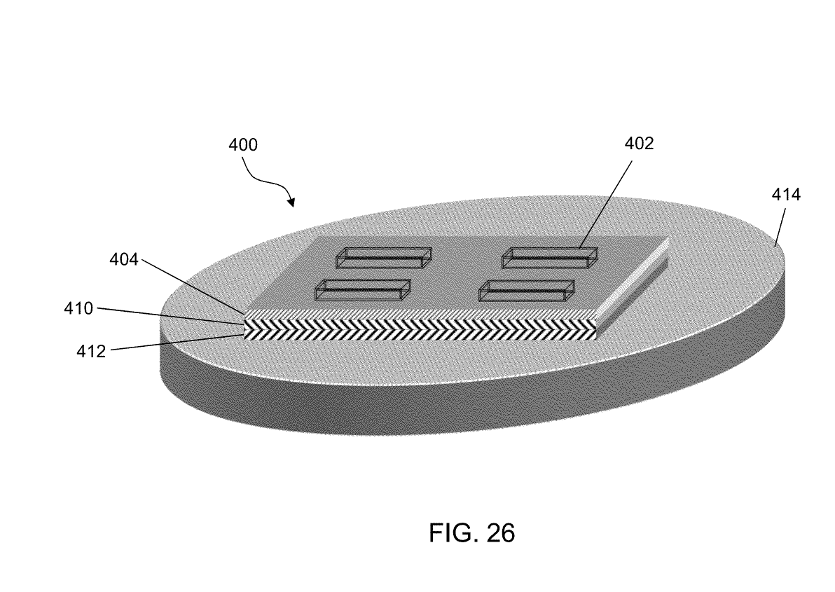

Another example of an application of the present invention is illustrated in FIG. 26. A thermal transformer 400 includes a 24 Watt LED array 402, with a first layer of copper 404, a second layer of aluminum 410, a third layer of glass 412, and a fourth layer of a compressed cellulose fiber board 414. The structure is 9 ins across.

### EXAMPLE

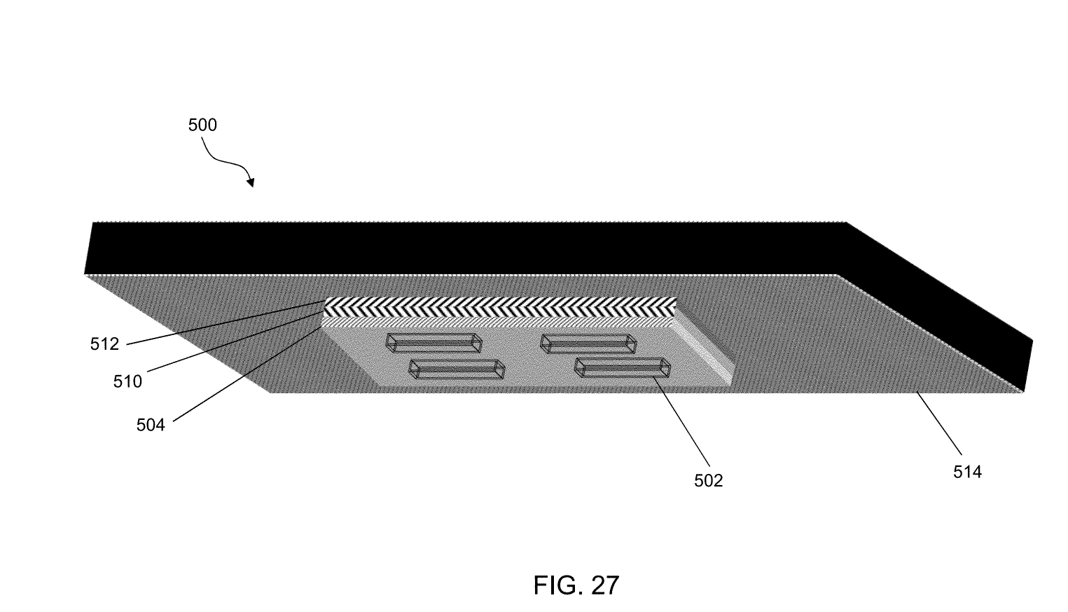

Another example of an application of the present invention is illustrated in FIG. 27. A thermal transformer 500 includes a 60 Watt LED array 502, with a first layer of copper 504, a second layer of aluminum 510, a third layer of glass 512, and a fourth layer of a cellulose paper ceiling tile 514. The structure is 24 ins square.

### EXAMPLE

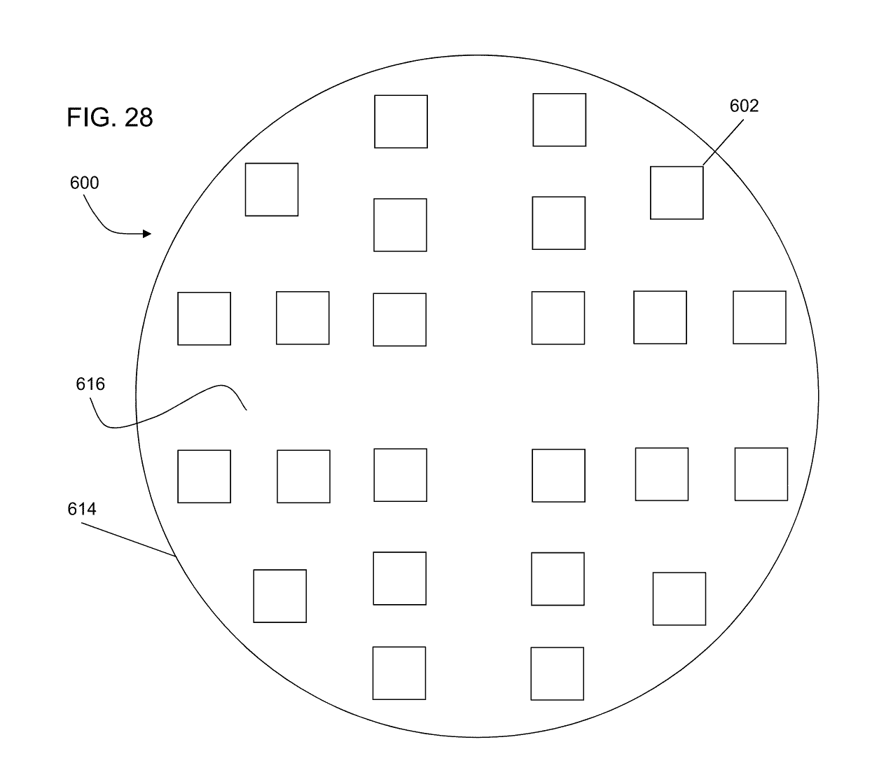

FIG. 28 is a system 600 having a 350 Watt LED array 602 where the final layer 614 is a concrete backing board. The concrete has an aluminum foil 616 to hide the concrete layer 614. Each LED is backed by first, second, and third layers of copper, aluminum, and stainless steel. The structure is 26 ins in diameter.

### EXAMPLE

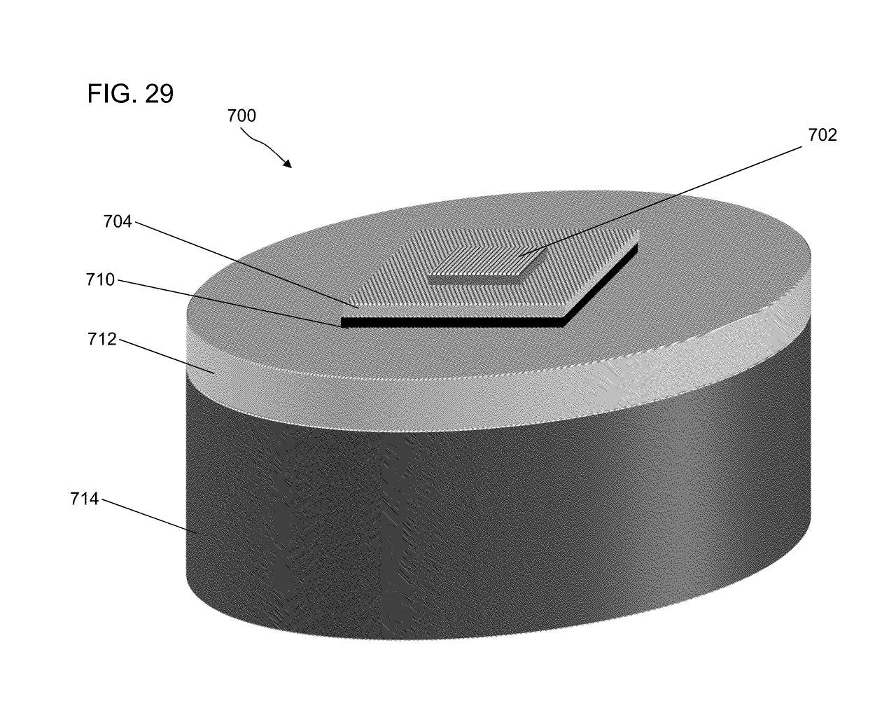

FIGS. 29-34 show an embodiment of the present invention incorporating a variable-gradient layer. In this embodiment, a system 700 has a 30 Watt LED 702 where there is a first layer 704 of a copper, a second layer 710 of aluminum, a third layer 712 of a stainless steel, and a fourth layer 714 of variable-gradient material.

The fourth layer 714 has a distributed thermal impedance, such that a thermal impedance gradient is established within the fourth layer 714. In this embodiment, the fourth layer 714 has a lower thermal resistivity at its top side next to layer 712 than at its bottom side which is exposed to air or insulation.

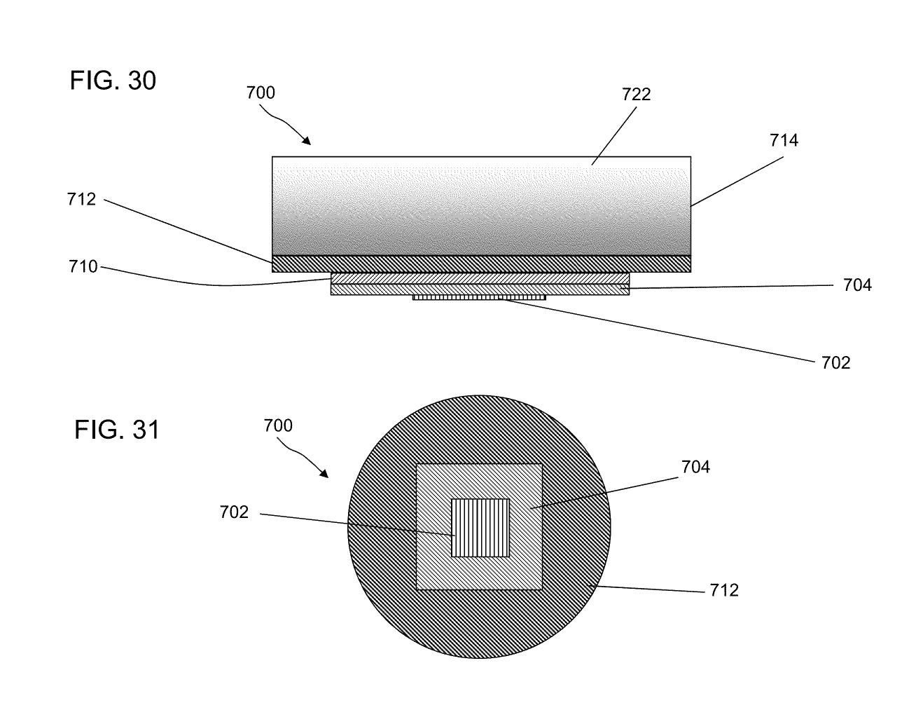

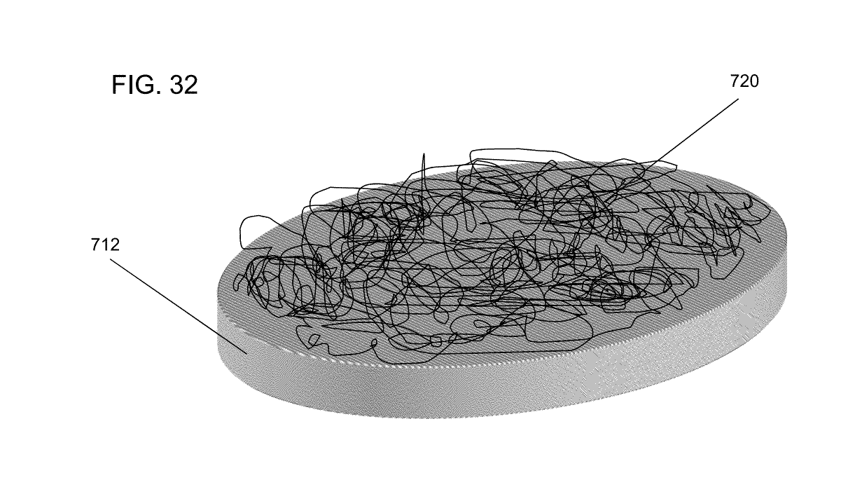

The fourth layer 714 (FIG. 30, FIG. 31) was formed by suspending stainless steel wool 720 from the third layer 712. (FIG. 32) The steel wool 720 was then impregnated with a lower thermal impedance mixture, in this case plaster of Paris 722, although plastic, concrete, or any other suitable material having the desired lower thermal impedance could be employed. In this example, the steel wool 720 was lowered into a vat of fluid plaster of Paris 722. A vacuum was used to extract any air within the vat. Once the plaster of Paris 722 was set (solidified), the first and second layers 704, 710 and the LED 702 were attached to the third layer 712 and the fourth layer 714 of the variable thermal impedance gradient material formed of the steel wool 720 and the plaster of Paris 722. The resulting structure was about 1.4 ins thick and 5.4 ins in diameter.

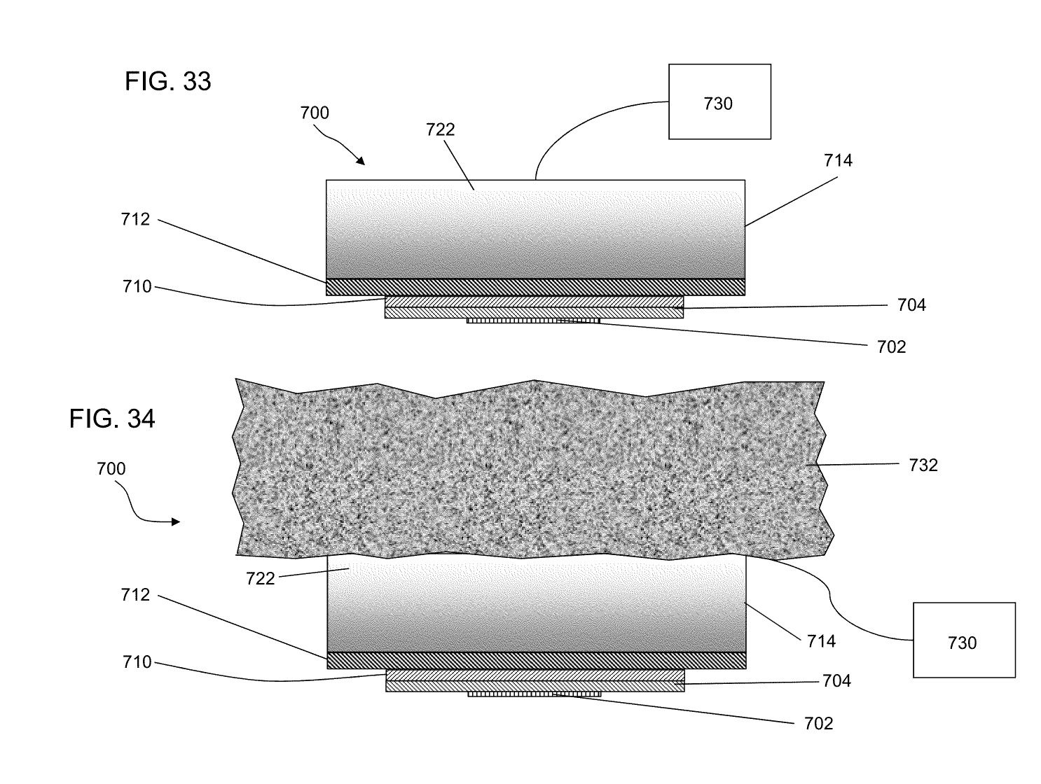

As shown in FIG. 33, the LED was connected to a power supply 730 and the operating conditions were measured. The LED operated at 22 Watts and the junction temperature was 90° C. between layers three 712 and four 714. At this temperature, the life of the LED would be well over 30K hours. The temperature of the boundary of the fourth layer 714 and ambient was about 60° C. at the center of the disk-shaped fourth layer 714 and about 58° C. at the outer diameter.

The operating condition was altered by adding 2ins of fiberglass insulation covering a top surface of the fourth layer disk 714, thus forming a fifth layer 732. (FIG. 34) The normal expectation would be a thermal catastrophe. However, at 25° C. ambient, the operating temperature of the LED was increased by about 2 degrees to 92° C.

The devices described in the examples generally use a technique of stacking or layering wherein a surface of each subsequent layer is in thermal communication, preferably engaging, a surface of the preceding layer as shown consistently throughout the figures.

The terms “first,” “second,” “upper,” “lower,” “top,” “bottom,” etc. are used for illustrative purposes relative to other elements only and are not intended to limit the embodiments in any way. The term “plurality” as used herein is intended to indicate any number greater than one, either disjunctively or conjunctively as necessary, up to an infinite number. The phrase “stacked relationship” is generally intended to indicate successive layers of material having thermal impedances. Layers in “stacked relationship” tend to engage successive layers in the stack. “Stacked relationship” includes successive annular layers as well as generally planar members and combinations of the same as described and shown in the drawings.

While the specific embodiments have been illustrated and described, numerous modifications come to mind without significantly departing from the spirit of the invention, and the scope of protection is only limited by the scope of the accompanying claims.

What is claimed is:

1. A method of passively dissipating heat from a source of heat comprising the steps of:
forming a plurality of successive layers of thermally conductive materials each having a thermal conductivity less than a thermal conductivity of a preceding layer wherein the plurality of successive layers comprises at least a first layer, a second layer, and a third layer in stacked relationship; and
matching thermal impedances of the plurality of successive layers from one layer to an adjacent layer in the plurality of successive layers by controlling a volume of one layer relative to an adjacent layer in the plurality of successive layers.

2. The method of claim 1 wherein at least one layer in the plurality of successive layers comprises an insulating material.

3. The method of claim 2 wherein the insulating material comprises a thin film.

4. The method of claim 3 wherein the thin film is a polyester thin film.

5. The method of claim 1 wherein each subsequent layer in the plurality of successive layers in a direction moving away from the source of heat has a surface area greater than a surface area of a preceding layer.

6. The method of claim 1 wherein the first layer, second layer and third layer are produced from different metallic materials.

7. A thermal transformer to conduct heat away from at least one light emitting diode comprising:
at least one light emitting diode having a surface area; and
a plurality of successive layers of materials having dissimilar thermal conductivities wherein a first layer adjacent the light emitting diode has a first thermal conductivity greater than a second thermal conductivity of a subsequent layer in the plurality of successive layers of materials and wherein a surface area of a final layer in the plurality of successive layers of materials which conducts heat to the environment is greater than 50 times the surface area of the at least one light emitting diode.

8. The thermal transformer of claim 7 wherein at least two layers of different materials are located between the light emitting diode and a heat sink and wherein each successive layer moving away from the light emitting diode has thermal conductivity less than the thermal conductivity of the preceding layer.

9. A thermal transformer for use to remove heat from a light emitting diode wherein a lateral thermal resistance is less than a vertical thermal resistance for a 1 centimeter diameter area including the light emitting diode.

10. A thermal transformer for conducting heat away from a light emitting diode on a circuit board comprising:
a light emitting diode having a surface area;
a first layer of a first metallic material having a surface area in engagement with a part of the light emitting diode wherein the surface area of the first layer immediately adjacent to the light emitting diode is at least 8 times the surface area of the light emitting diode;
a second layer of a second material spaced from the light emitting diode by the first layer; and
a heat sink interface spaced from the first layer by the second layer.

11. The thermal transformer of claim 10 wherein the first layer and the second layer are produced from different materials and the material of the first layer has a higher thermal conductivity than the material of the second layer.

12. The thermal transformer of claim 10 further comprising at least three layers of differing materials between the light emitting diode and the heat sink wherein each successive layer away from the light emitting diode has a lower thermal conductivity than a preceding layer.

13. A thermal transformer to conduct heat away from light emitting diodes in which two or more layers exist between a light emitting diode and a heatsink, characterized in that at least two of the layers have a thermal resistance which is the same within 50% and one of the at least two layers further away from the light emitting diode has a higher thermal resistivity than the other of the at least two layers closer to the light emitting diode.
